(19) United States
(12) Patent Application Publication
(10) Pub. No.: US 2007/0016703 A1
(43) Pub. Date: Jan. 18, 2007

(54) Method for generatimg and playing back a media file

(76) Inventors: Bruno Bozionek, Borchen (DE); Thomas Hanna, Detmold (DE); Klaus-Josef Kunte, Borchen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/569,141

(22) PCT Filed: Jul. 20, 2004
(86) PCT No.: PCT/EP04/51555

§ 371 Date: Feb. 21, 2006

(30) Foreign Application Priority Data
Aug. 22, 2003 (DE) 10338696.3

(51) Int. Cl. G06F 13/12

(52) U.S. Cl. 710/68

(57) ABSTRACT

The invention relates to a method for playing back a media file in a playback unit, comprising the retrieval of the executable instructions contained in the media file by the playback unit, the execution of the instructions for decoding and/or decompressing a media data flow that is stored in the media file in a coded or compressed manner by an execution device of the playback unit and playback of the media data flow by means of the instructions executed in the execution device. The invention also relates to a method for generating a media file, comprising coding an/or compressing a media data flow with the aid of a processing algorithm, definition of a processing algorithm that is complementary to the processing algorithm as instructions that are executed by the playback unit and assembling the media file with a first area for receiving the coded and/or compressed media data flow and at least a second area for receiving the executable instructions.

### CROSS REFERENCE TO RELATED APPLICATION

This application is the US National Stage of International Application No. PCT/EP2004/051555, filed Jul. 20, 2004 and claims the benefit thereof. The International Application claims the benefits of German Patent application No. 10338696.3 DE filed Aug. 22, 2003, both of the applications are incorporated by reference herein in their entirety.

### FIELD OF THE INVENTION

The invention relates to a method and an arrangement for generating and playing back a media file.

### BACKGROUND OF THE INVENTION

The bandwidth available in the transmission of data via packet-oriented data networks increasingly permits the transmission of audiovisual media via data networks such as e.g. the Internet or intranets. Such audiovisual media include e.g. films, film sequences or audio information in the form of spoken lectures or readings, music sequences and much more. A presentation of information which in addition to the displaying of text also comprises a partial or full use of audiovisual media is often also called multimedia communication.

It is known for the audiovisual information that is to be exchanged to be compressed from an uncompressed video or audio flow using a compression algorithm and for the compressed data to be stored in a file. The stored file—hereinafter also called a media file—is available e.g. on a service-providing computer system—among experts also called a server—for transmission via a data network or is stored on a data carrier.

After a user has fully or partially stored a media file transmitted via the data network on a local computer system—among experts also called a client—it is possible for the media file to be played back on the local computer system. The media file is played back by means of a playback unit. Such a playback unit is available as software on a computer system.

In addition to a playback unit executed as software on a computer system, playback units are also known which are fashioned as stand-alone devices in the form of a playback device. The media file is usually retrieved on such playback units from a data carrier. For example, optical data carriers such as for example a compact disk, CD, digital versatile disk, DVD etc, or even electronic memories are used as data carriers. Playback units with an integrated electronic memory are known which are suitable for the mobile presentation of audio information. The media file is retrieved on such playback units from a computer system or else directly from a data network.

In order to play back the video or audio flow that is present in compressed form on the playback unit, firstly execution of a decompression algorithm is required in which a decompressed video or audio flow is generated from the compressed media file. This decompressed video or audio flow is played back by means of the playback unit. The decompression and the playback are usually carried out alternately in sequence over time.

The abbreviation “codec” (compression-decompression) is commonly used among experts to jointly define the compression and decompression algorithm. A codec is understood to refer to the principle of being able to compress an uncompressed video and/or audio flow according to a defined algorithm and of being able to decompress a compressed video and/or audio flow again.

Despite the increasing bandwidth, referred to initially, in the transmission of media files and despite the increasing storage capacity of data carriers, the effective compression of media contents continues to be a paramount requirement. For this reason, new compression and associated decompression methods—codecs—by means of which the size of the media file is designed to be reduced while the quality of the media contents remains virtually unchanged are continuously being developed. The standard for the quality of media contents that is striven for is e.g. a quality impression of a human recipient or else technical requirements for the further processing of the media file such as e.g. by means of the “cutting” of video sequences.

From the plurality of codecs available, a sample selection is presented below:

MPEG (Motion Picture Experts Group) codecs are suitable for storing films in a space-saving manner. A basic principle of the MPEG compression method is to evaluate differences between image sequences of the video data flow. Since in many scenes of a film a background remains constant over a fairly long period, compression methods based on the MPEG codec achieve efficient compression by virtue of the fact that only differences between the image sequences are stored. A disadvantage of the MPEG codec is consequently that this method is less suitable for a digital cut of film sequences. MPEG codecs currently exist in different versions, with the MPEG1, MPEG2 and MPEG4 versions currently finding widespread use.

A method for compressing and decompressing audio information is the MP3 codec. MP3 is likewise an MPEG compression method for compressing audio signals. The MP3 codec takes physiological properties of human hearing into account and, compared with uncompressed audio files, permits a substantial saving of storage space. According to the method, in MP3 portions of the signal which are reflected in “critical frequency bands” are filtered out. These are bandpasses of differing bandwidth which together cover the human hearing range. The filtering is accompanied by a DCT transformation (discrete cosine transformation) or a Fourier transformation which transfers the time-related audio signal into the frequency layer. The filtering is followed by an evaluation of the information content of the individual filtered proportions. This evaluation establishes the digitalization.

Among experts, further audiovisual codecs are known under the names “QuickTime”, “RealVideo”, “DivX”, H.261 etc.

The above-described use of codecs for playback in a playback unit includes several disadvantages:

Due to the aforementioned plurality of different codecs, a playback unit has to have implemented different codecs in order to playback several different media files. In particular, a playback unit is not capable of playing back an unknown media file. Especially where the playback unit is implemented in hardware, restriction to the codec current at the time of manufacture of the playback unit is disadvantageous.

The codecs available to a playback unit are intended to cover a broad range of possible variations in the format of the media content. A very general implementation is required for this broad coverage, as a result of which the codecs are, overall, structured in a more comprehensive and complex manner.

For media files which have been generated in accordance with a specific codec but one which nonetheless deviates from the norm, playback on the playback unit is not therefore guaranteed.

A media file compressed in accordance with the standards of the codec is, despite a possible copyright protection, susceptible to unauthorized copying. The reasons for this lie in the fact that a single method for circumventing the copyright protection for a certain type of media file can be used for all data carriers of this type.

Even partial restriction of usability is not possible by separating the playback unit and the media file. It does, however, seem in many cases to be desirable to numerically restrict the playback of audiovisual media or else to render the playback accessible only to a selected circle of users. The idea of accomplishing the one-off playback of audiovisual media using self-destructible data carriers is under consideration. The methods proposed for doing so relate, however, to the data carrier and not to the media file itself.

### SUMMARY OF THE INVENTION

The object of the invention is to indicate means for generating and playing back a media file through which the problems of the prior art can be avoided.

The object is achieved in a method having the features of the claims.

The invention provides a method for playing back a media file in which executable instructions contained in the media file are retrieved by the playback unit. The executable instructions form a “medialet”, i.e. a software for the decoding and/or decompressing of the media data flow stored in the media file in a coded and/or compressed manner by an execution device of the playback unit. The executable instructions activate, after or at the same time as this decoding and/or decompressing, playback of the media data flow stored in the media file. The invention thus provides playback by means of the medialet rather than by means of an execution routine or software of the playback unit.

A further aspect of the invention relates to a method for generating the mentioned media file, wherein firstly a media data flow is coded and/or compressed with the aid of a processing algorithm. The media data flow is retrieved e.g. direct from an audiovisual media signal source, or else from an e.g. uncompressed second media file. The media data flow can especially—in the form of a visual medium—also exist in the form of a presentation, i.e. in a sequence of static or animated graphics or “slides”. With the aid of a processing algorithm complementary to the selected processing algorithm, in other words, a codec, executable instructions are generated by a generating unit which are also referred to hereinbelow as a “medialet”. The executable instructions thus contain the codec and offer, in addition, a platform-independent generator for generating the media data flow contained in the media file in a compressed and/or coded manner. This means that the playback unit playing back the media file later has to contain only an execution device by means of which the runtime environment is started with the aid of the executable instructions. The entire software for playing back and for controlling this playback, on the other hand, is contained in the executable instructions. The media file is finally generated with a first area for receiving the coded and/or compressed media data flow and at least one second area for receiving the executable instructions.

A substantial advantage of the method according to the invention is to be seen in the fact that the codec is implemented platform-independently. The execution device of the playback unit offers a so-called runtime environment and provides an interface for playing back the media flow. The actual generation of the media flow is carried out with the medialet containing the codec, not by means of the playback unit.

Advantageously, no restrictions in terms of the characteristics of the playback unit have to be allowed for in generating the media file. Without the inventive means, such a disadvantageous allowance is currently often made in MP3 players or even in various multimedia-capable mobile phones.

The restriction that present-day systems—particularly embedded systems with minimal computing and storage capacity—are, due to a finite number of codecs being available, i.e. stored in this system, able to display only one or a few media formats, is advantageously eliminated by means of the codec, which is always supplied jointly.

The relationship between a data volume of a conventional codec and a data volume of a customary media content is very small, so inclusion of the codec in the media file according to the invention advantageously does not enlarge this media file considerably. In addition, a conventional codec is always designed for a wide bandwidth of different variations of the associated compressing and/or decoding standard, which increases its data volume considerably. By comparison, the codec according to the invention is precisely matched to the media contents in the shared media file, and it is therefore smaller in terms of its data volume than a conventional codec.

Due to a restriction caused inter alia by operating systems, in current data information systems one and the same media content is often generated and offered in multiple formats. The offer normally provides for retrieval of the media content for example in “encoded for Windows Media Player” format and in “encoded for RealOne Player” format. Using the means according to the invention, this additional outlay no longer applies at all. Advantageously, the outlay on storage space in the data information systems—for example so-called “provider” systems—is significantly reduced as a result.

Advantageously, high-outlay codec algorithms consequently no longer have to be implemented on different hardware or software platforms for testing purposes and checked as to their conformity.

It is furthermore advantageous that the principle of reloadable and installable codecs is completely eliminated. Software maintenance of this type has been rendered superfluous by the inventive principle of “joint delivery” of the appropriate codec within the media file in each case.

A further advantage consists in the future-proof usability of playback units, especially in non-computer-aided implementations of the playback unit, for example in a playback device. With the development of new codecs, playback advantageously remains guaranteed even with the existing hardware and/or software configuration of a playback unit.

Using the means of the invention, the codec can be freely adapted to the media content. This results in particular in an efficient adaptation of the codec to the media contents. For example, for a “quiet” film with few cuts or picture changes, an appropriately adapted codec can be used, and for a dynamic film such as, for example, a music video with rapid scene changes and enhanced requirements in terms of audio quality, a codec correspondingly adapted to this media type can be used. Mandatory selection of a predetermined codec standard is thus dispensed with in favor of a codec tailored to the respective media content.

A further advantage of a freely adaptable codec is that the media content contained in the media file no longer has to conform to standards in a variety of ways, and unauthorized reading out—also referred to among experts as “ripping”—and unauthorized copying is therefore prevented. By virtue of the fact that the codec within the executable instructions and the media content are matched to one another, separation is not possible. Playback is possible only together with the executable instructions which, with a check of the playback conditions, permit a restriction of playback. Unauthorized playback is thus inherently prevented with the means according to the invention.

A further advantage of the method according to the invention is that with an extension of the possible uses for playback units, especially in the area of e-learning, e-business and e-book applications, no changes are required in the playback unit itself. Advantageous transparent processing of media files is thus enabled for the respective playback units.

Advantageous further developments of the invention are specified in the subclaims.

In an advantageous manner, playback of the media file is activated with the aid of the executable instructions and in this way the necessity of adapting to different playback units avoided.

Implementation of these executable instructions independently of an operating system available for the playback unit in order to enable playback for all possible playback units is also advantageous.

Prior to playback, carrying out a check of playback conditions such as, for example, a number of possible playbacks that can be configured in the media file and/or a date and/or a writeability of a data carrier used for storing the media file and/or performance features of the playback unit is of particular advantage. By this means, a restriction of usability can be achieved in a simple manner, e.g. it can be ensured that the media flow can be played back only on writeable data carriers and/or only a specified number of playbacks can take place. Naturally, this number of permitted playbacks can also be set to a value of “one”, and in this way the method according to the invention offers a simpler way of implementing a restriction on use than a self-destroying data carrier, for example, is supposed to achieve. In the case of rewriteable data carriers, the executable instructions also enable a planned deletion of the media content after a predeterminable number of permitted playbacks.

In an advantageous manner, at least one area that is contained in the media file for defining prerequisites and/or performance characteristics of the playback unit—also called the “codec capabilities” area—is provided for checking playback conditions. In the course of a so-called “capability exchange” matching procedure, physical prerequisites of the playback unit can advantageously be matched to the requirements of the media file. Physical prerequisites can be deemed to include, for example, playback options such as e.g. the absence of a visualization option for example in audio devices, or else audio processes supported such as e.g. “mono” or “stereo”.

If the result of this check of playback conditions is that the media contents cannot be played back—i.e. the outcome of the check is negative—in an advantageous embodiment playback does not occur. This is of particular advantage if a restriction on playback is implemented for specified target groups, for specified environments or for times of day. A further use of this advantageous embodiment is provided by a restriction on the number of possible playbacks of the media contents. In particular, a restriction to a single playback can be set.

In an advantageous manner, a parameter area is provided in the media file in which specialized parameters for the playback of the media content by the medialet or by the executable instructions are held. In this way, the codec contained in the executable instructions is parameterizable so that the media content does not have to conform to any specific playback standard.

### BRIEF DESCRIPTION OF THE DRAWINGS

An exemplary embodiment comprising further advantages and developments of the invention is explained in detail below with the aid of the drawings, in which:

FIG. 1A: shows a structogram for the schematic representation of a structure of a media file according to the invention and

FIG. 1B: shows a structogram for the schematic representation of a structure of a code area of the media file according to the invention.

### DETAILED DESCRIPTION OF THE INVENTION

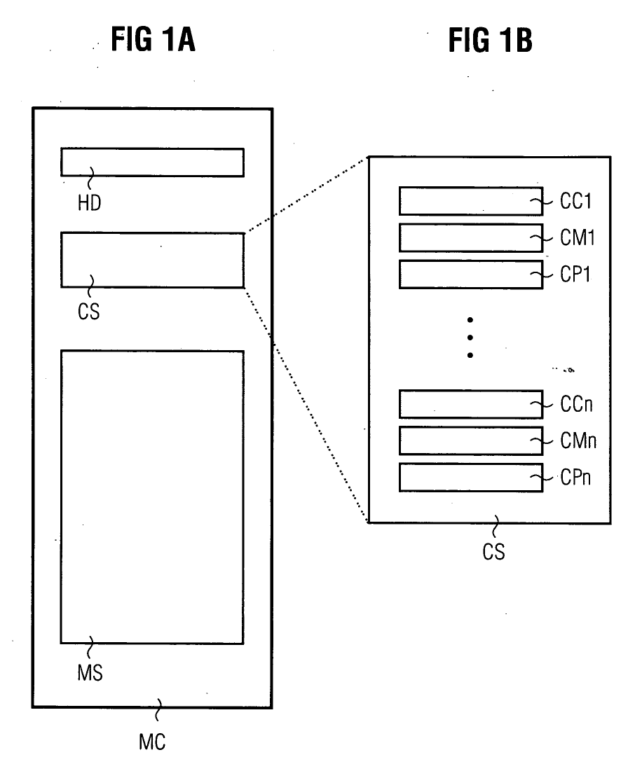

FIG. 1A shows a media file MC. In the preferred embodiment this media file MC is also referred to by the term “media container” MC in order to express that, in addition to media contents, this media file MC also contains further functional components. The media file MC is provided for execution in a playback unit (not shown). Playback and generation of this media file MC are discussed in detail further below.

One component of the media file MC is a header entry area HD which is provided for entering header information. The header information serves for example to identify the media file MC and also has the function of a table of contents.

A further component of the media file MC is a code area CS which contains the executable instructions and a codec. The codec area CS is also called a “codec section”. The codec is provided either separately from the executable instructions or else as a unit with these in the codec area CS. Details relating to the codec area CS will be explained further below.

A further component of the media file MC is a media content area MS which contains the compressed and/or coded media contents. The media content area MS is also called the “media content section”.

The structuring of the media file provided in this exemplary embodiment into the above-mentioned areas HD, CS, MS can alternatively also be achieved by means of different structures.

In order to conceal the chosen structure, in an alternative embodiment a scrambling method is used which encrypts some of the data contained in the media file MC and also renders access to the media contents in the media content area MS difficult. The encryption is carried out for example using a key exchange system: here the playback unit has a secret key (player key). By means of this secret key the playback unit identifies itself to the executable instructions of the media file MC. After successful checking, the media file MC surrenders two keys, using which the playback unit decodes and processes the data of the media file MC.

The codec in the codec area CS of the media file MC is minimal in terms of its size—i.e. in terms of its data volume normally specified in “Byte” units—since it is defined only for the media contents pinpointed in the media content area MC. Advantageously, special cases or different types of playback do not therefore have to be taken into account. Codecs known from the prior art for playing back audiovisual media contents have to have implemented the various specified playback types and special formats of media contents. The codec according to the invention, by contrast, can comprise a substantially smaller volume of data. In view of the ratio of the data volume of the codec to the media content area MS, which in the case of a film sequence normally comprises several Megabytes, the contribution of the codec to the overall data volume of the media file MC is consequently negligible.

A detailed layout of the code area CS will be explained in greater detail below with further reference to the components shown in FIG. 1A.

The code area CS is subdivided in an alternative embodiment according to FIG. 1B into a first area for defining prerequisites and/or performance characteristics CC1 which serves to define codec capabilities.

Furthermore, a medialet area CM1 which contains the executable instructions and the codec is arranged in the codec area CS.

A first parameter area CP1 in the codec area CS serves to accommodate the parameters required for executing the medialet.

For a further structuring of the codec area CS, a further n areas CCn,CMn,CPn are arranged in addition to these first areas CC1,CM1,CP1.

When the described media file MC is played back, executable instructions contained in the codec area CS are retrieved by the playback unit (not shown). The executable instructions form a “medialet”, i.e. software for the decoding and/or decompressing of the media data flow stored in a coded and/or compressed manner in the media content area MS by an execution device (not shown) of the playback unit. The execution device of the playback unit provides for this purpose an environment for the executable instructions, which is often called a “runtime environment”. In addition, the execution device provides an interface for playing back the media contents.

After, or at the same time as, this decoding and/or decompressing, the executable instructions activate a playback of the media data flow stored in the media content area MS. The actual generation is then effected by the executable instructions, not by devices of the playback unit.

Before the media data flow is generated, a check is optionally carried out by the executable instructions to establish whether the conditions for playback are provided. These conditions include, for example, the number of previous playbacks, the current date, a rewriteability of the data carrier on which the media file MC is stored or the existence of defined performance characteristics in the playback unit. Playback, controlled by the executable instructions, is optionally denied.

Optionally, after a playback has been completed, the media file MC is deleted if, for example, only a single playback or a usage restricted to a specified number of playbacks is desired by the originator of the media file MC.

When the media file MC is generated, firstly a coding and/or compressing of a media data flow (not shown) is carried out with the aid of a processing algorithm (not shown). The media data flow is retrieved e.g. direct from an audiovisual media signal source (not shown), or else from an e.g. uncompressed second media file (not shown). The media data flow thus coded and/or compressed is held in the media content area MS of the media file MC.

Furthermore, the codec used for coding and/or compressing the media contents is embedded by the generating unit in executable instructions or alternatively furnished with these and these inserted into the codec area CS of the media file MC.

The media file is finally furnished by the generating unit with the header entry area HD.

1-21. (canceled)

22. A method for playing back a media file in a playback unit, comprising the following steps:
retrieval of executable instructions contained in the media file by the playback unit;
execution of the instructions for decoding and/or decompressing a media data flow that is stored in the media file in a coded or compressed manner by an execution device of the playback unit; and
playback of the media data flow by the instructions executed in the execution device.

23. The method according to claim 22, wherein the media data flow is an audio medium.

24. The method according to claim 22, wherein the media data flow is an audiovisual medium.

25. The method according to claim 22, wherein the media data flow is a visual medium.

26. The method according to claim 22, wherein the execution device activates the playback of the media file with the aid of the executable instructions.

27. The method according to claim 22, wherein the executable instructions are implemented independently of an operating system available for the playback unit.

28. The method according to claim 22, wherein before the media file is played back by the executable instructions, a check of playback conditions is carried out.

29. The method according to claim 28, wherein that for the checking of playback conditions a number of adjustable playbacks, and/or a date, and/or a writeability of a data carrier used for storing the media file, and/or performance features of the playback unit are evaluated.

30. The method according to any one of claim 28, wherein for checking of playback conditions, at least one area contained in the media file is used for defining prerequisites and/or performance features of the playback unit.

31. The method according to claim 30, wherein prerequisites and/or performance features of the playback unit are matched to prerequisites and/or performance features provided in the media file.

32. The method according to claim 28, wherein the playing back of the media file does not occur if the result of the check of playback conditions is negative.

33. The method according to claim 22, wherein for decoding, and/or decompressing, and/or checking playback conditions, and/or playing back the media file, parameters are used which are grouped in a parameter area of the media file.

34. A method for generating a media file, comprising the following steps:
coding and/or compressing a media data flow with a processing algorithm;
defining a processing algorithm that is complementary to the processing algorithm as instructions that are executed by a playback unit; and
assembling the media file with a first area for receiving the coded and/or compressed media data flow and at least one second area for receiving the executable instructions.

35. The method according to claim 34, wherein the media data flow is an audio medium.

36. The method according to claim 34, wherein the media data flow is an audiovisual medium.

37. The method according to claim 34, wherein the processing algorithm and/or the processing algorithm that is complementary to the processing algorithm is a codec.

38. The method according to claim 34, wherein at least one area for defining prerequisites and/or performance features of the playback unit is inserted into the media file.

39. The method according to claim 34, wherein at least one area for defining parameters that can be used by the executable instructions is inserted into the media file.

40. The method according to claim 34, wherein the method is incorporated in a program product with program code for implementing the method if the program product is running on a computer system assigned to the playback unit.

41. The method according to claim 34, wherein the method is incorporated in a program product with program code for implementing the method if the program product is running on a playback system assigned to the playback unit.
